(19) United States
(12) Patent Application Publication
(10) Pub. No.: US 2025/0197185 A1
(43) Pub. Date: Jun. 19, 2025

(54) REMOVABLE FLAVOR FUNNEL

(71) Applicant: SharkNinja Operating LLC, Needham, MA (US)

(72) Inventors: Dimarco Bowes, London (GB); Jack Richardson, Rawcliffe (GB); Jemma Beedie, London (GB); Hamish Thompson, London (GB)

(21) Appl. No.: 18/545,248

(22) Filed: Dec. 19, 2023

(51) Int. Cl. B67C 11/02; B67D 1/00

(52) U.S. Cl. CPC B67C 11/02; B67D 1/0042; B67D 2210/00055

(57) ABSTRACT

In one embodiment, a beverage system is provided and includes a beverage dispenser and a funnel removably coupled to the mounting ring. The funnel can be configured to receive a primary fluid and an additive, and the funnel can include a mixing chamber configured to combine the primary fluid and the additive into a combined fluid. The mixing chamber can include a plurality of ribs configured to direct the combined fluid toward a funnel outlet. The funnel can further be configured to receive the primary fluid through a primary outlet of the beverage dispenser, and the primary outlet can be positioned substantially tangential to a curve of the funnel such that a fluid vortex is formed in the mixing chamber. Additionally, the funnel can be configured to receive the additive from at least one secondary outlet of the beverage dispenser.

### FIELD

Funnels for use with beverage dispensing systems are provided.

### BACKGROUND

Generally, when a user wishes to use a beverage system to combine carbonated water with a flavor additive, the system can fail to deliver a harmonious fusion of texture and flavor. Oftentimes, the vigorous mixing that is required to blend carbonated water with an additive can result in a loss of carbon dioxide. Additionally, the combined mixture can take a significant amount of time to drain out of the system and into the user's cup, which can cause fluid to drip from the system even after the beverage has been dispensed.

### SUMMARY

Funnels for use with beverage dispensing systems are provided.

In one embodiment, a beverage system is provided and includes a beverage dispenser and a funnel removably coupled to the beverage dispenser. The funnel can be configured to receive a primary fluid and an additive, and the funnel can include a mixing chamber configured to combine the primary fluid and the additive into a combined fluid. The mixing chamber can include a plurality of ribs configured to direct the combined fluid toward a funnel outlet. The funnel can further be configured to receive the primary fluid through a primary outlet of the beverage dispenser, and the primary outlet can be positioned substantially tangential to a curve of the funnel such that a fluid vortex is formed in the mixing chamber. Additionally, the funnel can be configured to receive the additive from at least one secondary outlet of the beverage dispenser.

The beverage system can have various configurations. In some aspects, each rib of the plurality of ribs can extend radially outward from the funnel outlet toward a curve of the funnel. In certain embodiments, each rib of the plurality of ribs can be positioned tangentially to the funnel outlet. Further, the plurality of ribs can include three ribs evenly spaced apart from each other. In some aspects, the funnel outlet can include three openings, and each rib can be configured to direct fluid to a respective one of the three openings.

In other embodiments, the primary fluid can comprise carbonated water.

In further embodiments, the funnel can be bowl-shaped.

In other aspects, the funnel can include a protrusion, and the protrusion can be configured to actuate an input disposed on the beverage dispenser. In some aspects, the beverage dispenser can be operable only when the input is actuated by the protrusion.

In another embodiment, a beverage system is provided and includes a beverage dispenser, a mounting ring pivotally connected to the beverage dispenser, and a funnel removably coupled to the mounting ring. The funnel can be configured to receive a primary fluid and an additive, and the funnel can include a mixing chamber configured to combine the fluid and the additive into a combined fluid. Further, the mounting ring can be configured to support the funnel within the mounting ring and to pivot away from the beverage dispenser in a first position and toward the beverage dispenser in a second position.

In some embodiments, the mounting ring can be attached to the beverage dispenser by at least one coupling member, and the mounting ring can be configured to pivot from the first position to the second position at the at least one coupling member.

In other aspects, the funnel can further include a protrusion, and the protrusion can be configured to actuate an input. Additionally, in some embodiments, the beverage dispenser can be operable only when the input is actuated by the protrusion. Further, the protrusion can be configured to actuate the input when the mounting ring is in the second position.

In other embodiments, the funnel can be configured to receive the primary fluid through a primary outlet of the beverage dispenser, and the primary outlet can be positioned substantially perpendicular to a funnel outlet such that a fluid vortex is formed in the funnel. Additionally, the funnel can be configured to receive the additive through at least one secondary outlet of the beverage dispenser, and the at least one secondary outlet can be positioned vertically above the funnel. Further, the mounting ring can be configured to pivot away from the primary outlet and the at least one secondary outlet when the mounting ring is in the first position.

In other aspects, the primary fluid can comprise carbonated water.

In other embodiments, the mixing chamber can include a plurality of ribs configured to direct the combined fluid toward the funnel outlet.

### BRIEF DESCRIPTION OF THE DRAWINGS

These and other features will be more readily understood from the following detailed description taken in conjunction with the accompanying drawings, in which:

FIG. 1A is a front view of one embodiment of a beverage system;

FIG. 1B is a rear perspective view of the beverage system of FIG. 1A with a portion of the housing removed;

FIG. 2A is a top perspective view of a funnel for use with the beverage system of FIG. 1A;

FIG. 2B is a top perspective view of another embodiment of a funnel for use with the beverage system of FIG. 1A;

FIG. 3A is a bottom view of one embodiment of a “tri-star” funnel outlet for use with a funnel as disclosed herein;

FIG. 3B is a bottom view of a “tri-swirl” funnel outlet in accordance with another embodiment;

FIG. 3C is a bottom view of a “cross” pattern funnel outlet in accordance with another embodiment;

FIG. 3D is a side view of a “regular” projection funnel outlet in accordance with another embodiment;

FIG. 3E is a side view of a “flat” projection of a funnel outlet in accordance with another embodiment;

FIG. 3F is a side view of an “extended” projection of a funnel outlet in accordance with yet another embodiment;

FIG. 3G is a chart showing various possible combinations of features related to a funnel outlet for use with the beverage system of FIG. 1A;

FIG. 4A is a top view of a “Duo-Swirl” configuration of ribs of a funnel for use with the beverage system of FIG. 1A;

FIG. 4B is a perspective view of the “Duo-Swirl” configuration of the funnel of FIG. 4A;

FIG. 5A is a top view of a “Tri-Swirl 2.0” configuration of ribs of a funnel for use with the beverage system of FIG. 1A;

FIG. 5B is a perspective view of the “Tri-Swirl 2.0” configuration of ribs of the funnel of FIG. 5A;

FIG. 6A is a top view of a “Tri-Swirl 3.0” configuration of ribs of a funnel for use with the beverage system of FIG. 1A;

FIG. 6B is a perspective view of the “Tri-Swirl 3.0” configuration of ribs of the funnel of FIG. 6A;

FIG. 7 is a top view of a “Quad-Swirl 1.0” configuration of ribs of a funnel for use with the beverage system of FIG. 1A;

FIG. 8A is a cross-sectional side view of the funnel, a primary outlet, and a secondary outlet of the beverage system of FIG. 1A taken along the a-a line of FIG. 1A;

FIG. 8B is a cross-sectional side view of the funnel, a secondary outlet, and an input of the beverage system of FIG. 1A taken along the b-b line of FIG. 1A;

FIG. 8C is a cross-sectional side view of a cover and an input of another embodiment of a beverage system similar to the beverage system of FIG. 1A.

FIG. 9 is a perspective view of a funnel and a mounting ring usable with a beverage system according to an embodiment;

FIG. 10 is a cross-sectional side view of the funnel, mounting ring, and a latching member of the beverage system of FIG. 9; and

FIG. 11 is a partial perspective view of the latching member and a funnel cover of the beverage system of FIG. 9.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

As explained above, traditional beverage dispensing systems can struggle to blend carbonated water with flavor additives. In particular, vigorous mixing is often required to combine water with flavor additives, but when the water is carbonated, such strong mixing can diminish the carbon dioxide, resulting in a flatter drink than desired by a user. Additionally, the beverage fluid of traditional beverage dispensing systems can take a long time to empty into the user's cup, and the fluid can continue to drip out of the system even after the cup is filled. This dripping can result in unwanted mess and wasted fluid. In order to address these issues, funnels with curves and ribs are provided for use with beverage dispensing systems. The curve of the funnel can create a vortex of fluid to not only seamlessly blend fluid and additives together, but also to maximize the amount of carbon dioxide retained in the fluid when the fluid is carbonated. Additionally, the ribs can be positioned in the funnel between the curve and a funnel outlet to efficiently channel the fluid toward the funnel outlet for prompt filling of a user's cup without post-dispense dripping.

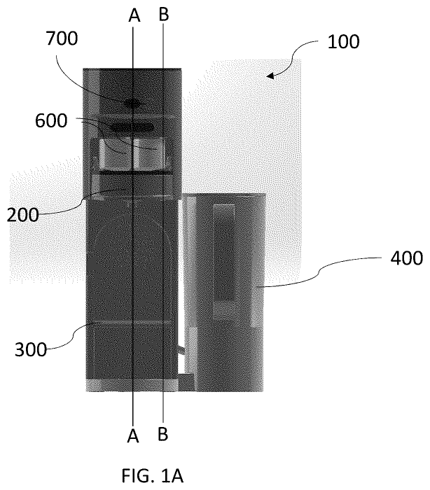

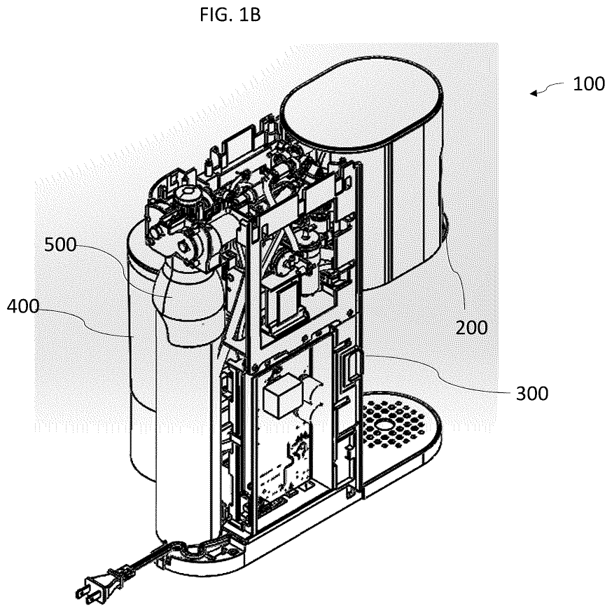

FIGS. 1A-1B illustrate one embodiment of a beverage system 100 having a funnel 200. The beverage system 100 can be used to create and dispense customized beverages for a user, based on desired characteristics of the beverage. As shown, a beverage system 100 is provided and generally includes a funnel 200, a beverage dispenser 300, a fluid reservoir 400, a carbon dioxide reservoir (not shown), additive containers 600, and a user interface 700. Optionally, the system 100 may include an attachment cap 500 for attaching the carbon dioxide reservoir to the system 100, but the carbon dioxide reservoir may alternatively be placed elsewhere within the system 100 so as to not require the attachment cap 500. The funnel 200 is designed to receive fluid and an additive from the beverage dispenser 300 for use in the creation of beverages. The containers 600 can include one or more additives (e.g., a flavorant, a vitamin, a food dye, etc.) to be included in a created beverage as desired. In some embodiments, two additive containers 600 can be used. A person skilled in the art will appreciate that the funnel disclosed herein can be used in any beverage dispensing system, including those that lack an additive container. Other beverage dispensing systems include, by way of non-limiting example, coffee, tea, beer, juice, and similar beverage-making apparatuses.

During a beverage dispensing process, a user can actuate controls located at a user interface 700 in order to select specific characteristics of the desired beverage, such as fluid volume and carbonation level. If the user selects controls to indicate that the beverage is carbonated, water can be fed from the fluid reservoir 400 and into a carbonation assembly (not shown), and carbon dioxide can be fed from the carbon dioxide reservoir (not shown) and into the carbonation assembly to produce carbonated water. The beverage can be dispensed into a vessel, such as a glass or bottle, from the beverage dispenser 300. Examples of beverage dispensing systems compatible with the funnel 200 provided herein may be found in U.S. patent application Ser. No. 17/989,640, entitled “INGREDIENT CONTAINERS FOR USE WITH BEVERAGE DISPENSERS” filed on Nov. 17, 2022, the contents of which are hereby incorporated by reference in its entirety.

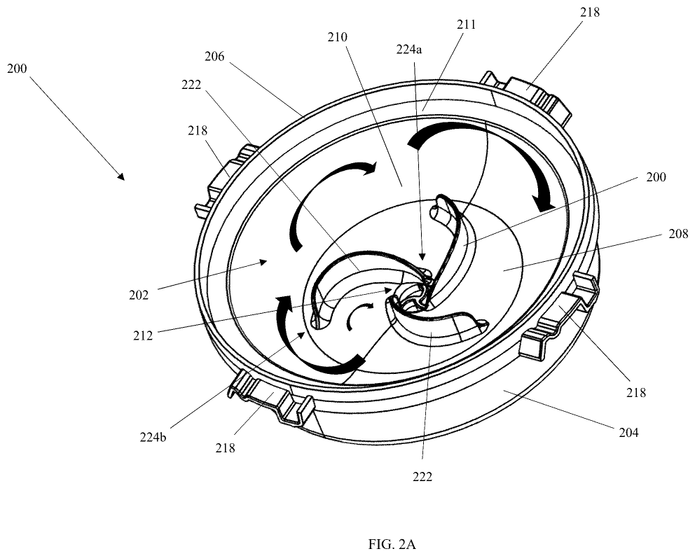

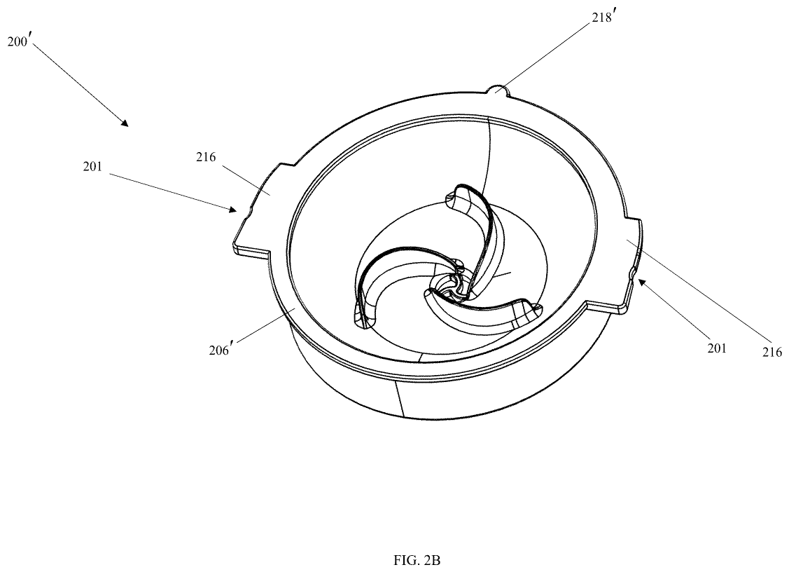

The funnel 200 of the beverage system 100 is illustrated in more detail in FIG. 2A. The funnel 200 can be made of any food-grade material, including various plastics (e.g., silicone), metals, or any other material suitable for holding fluid. As shown, the funnel 200 can include a mixing chamber 202, an outer wall 204, and a rim 206 extending around an upper circumference of both the mixing chamber 202 and the outer wall 204. The mixing chamber 202 can have a variety of configurations, but in the illustrated embodiment the mixing chamber 202 is generally bowl-shaped and includes a generally flat base 208 and a sidewall 210. The curved arrows imposed on the mixing chamber 202 are intended to demonstrate one path fluid can take to a fluid outlet 212. The base 208 can be pitched toward the funnel outlet 212 at some angle pitched from horizontal, as discussed below in more detail. The sidewall 210 can extend around a circumference of the mixing chamber 202 and taper outward from the base 208 to the rim 206 such that a diameter of the mixing chamber 202 is larger at the rim 206 than at the base 208. The sidewall 210 can further include a stepped region 211 adjacent to the rim 206, as shown in FIG. 2A.

The outer wall 204 can be generally cylindrical and can extend around an entire side circumference of the mixing chamber 202. In the illustrated embodiment, the outer wall 204 is formed as a unitary structure with the mixing chamber 202, but embodiments where the outer wall 204 is formed separately from the mixing chamber 202 are also considered by this application. The rim 206 can include one or more protrusions 218 designed to actuate an input 900. The input 900 is discussed below in more detail. The one or more protrusions 218 can each comprise an elongate member including various attachment regions for coupling the funnel 200 to a cover 230. As shown, the one or more protrusions 218 can be evenly spaced around the rim 206, however the outer wall 204 can have any number of protrusions or other mounting features at various locations.

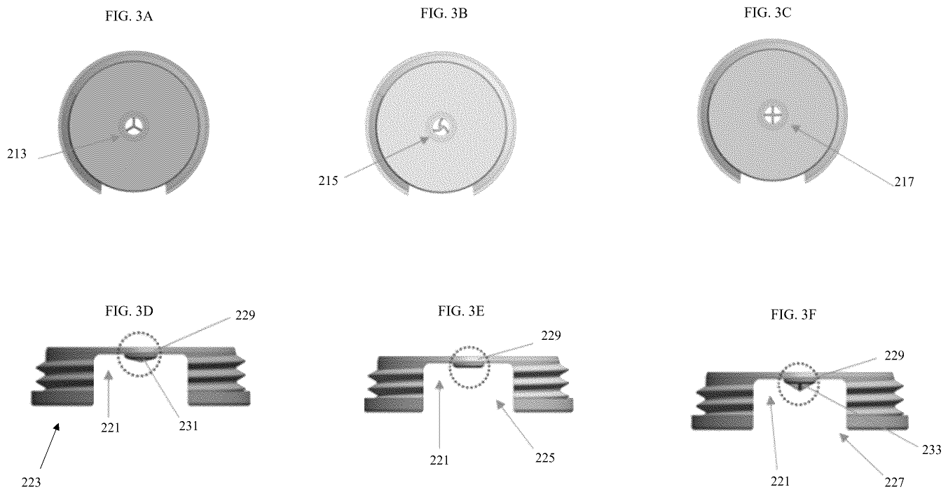

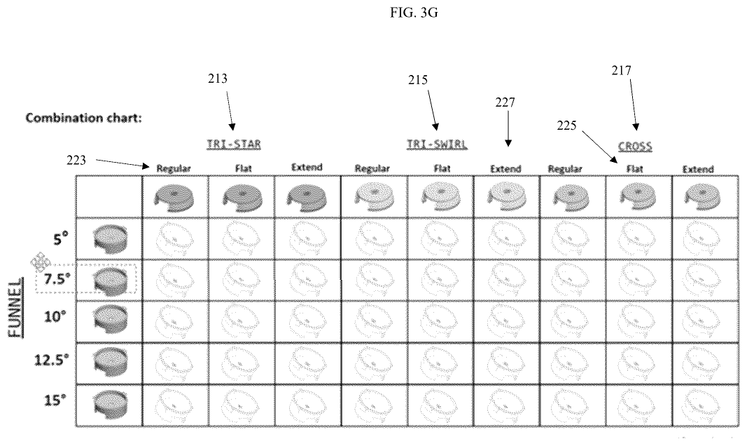

As discussed above, the base 208 can include the funnel outlet 212 with one or more openings to drain fluid from the mixing chamber 202. As shown in FIG. 2A, the funnel outlet 212 can be positioned in the center of the base 208 and the openings can be spaced apart from each other with each of the one or more openings forming part of a circle. The pattern 215 (FIG. 3B), also called a “tri-swirl” pattern, comprises three openings with each opening being shaped like a teardrop extending radially outward from a center of the funnel outlet 212. However, the funnel outlet 212 can include any number and shapes of openings suitable to efficiently drain fluid from the mixing chamber 202, which will be described in greater detail below, and in some embodiments can include a single opening,

The funnel 200 can further include one or more ribs 222 for guiding fluid to the funnel outlet 212. As shown in FIG. 2A, each of the one or more ribs 222 can comprise a raised elongate member that is curved to form an arc with filleted edges. Benefits of the filleted edges include improved carbonation of beverages and cleanliness of the funnel 200. As illustrated, each of the one or more ribs 222 can be raised above the base 208 high enough to direct fluid toward the funnel outlet 212 but low enough to be positioned below the rim 206. Overall, without the one or more ribs 222, the funnel 200 could continuously circulate fluid in the funnel 200 and risk exceeding fluid capacity, thereby creating a backflow of fluid into a primary outlet 228 (discussed below in more detail). To mitigate these risks, the one or more ribs 222 are designed to act as precision guides, effectively collecting and “pulling” fluid toward the funnel outlet 212 with precision so that the fluid drains quickly and efficiently.

The one or more ribs 222 can be positioned within the funnel 200 in various configurations. Each configuration discussed below can include the same elements discussed above, and as such only features that differ from those described above will be discussed. As depicted in FIG. 2A, the funnel 200 can include three ribs 222 that are evenly spaced apart and positioned within the mixing chamber 202 to extend radially outward from the funnel outlet 212 such that a first end 224a of each of the one or more ribs 222 lies adjacent to the funnel outlet 212 and a second end 224b of each of the one or more ribs 222 lies adjacent to the sidewall 210. In other words, each of the one or more ribs 222 can connect tangentially to the funnel outlet 212. Specifically, when the first configuration of ribs 222 is combined with the fluid outlet pattern 215, the one or more ribs 222 can be arranged in the mixing chamber 202 such that only one of the one or more ribs 222 curves around only one of the one or more openings of the funnel outlet 212. Further, that each respective one or more ribs 222 can span across the base 208 from the funnel outlet 212 to the sidewall 210 can streamline fluid flow from the mixing chamber 202 to the funnel outlet 212 in order to minimize the time it takes for fluid to travel out of the funnel 200 and into a user's vessel of choice.

A variation of the funnel 200, funnel 200′, is depicted in FIG. 2B. The funnel 200′ is similar to the funnel 200 in many ways, and for brevity, like features will not be described again. The one or more protrusions 218′ can each comprise a semi-circular projection extending from a rear surface of the rim 206′ equidistant between a plurality of ribs 216. However, it will be understood that the protrusion 218′ can be formed as any shape and positioned anywhere on the funnel 200′. The plurality of handles 216 can allow a user to grip the funnel 200′ to attach and remove the funnel 200′ from a corresponding system 100′, for example, when cleaning of the funnel 200′ is required. Further, the ribs 216 can be slid into corresponding rails on a funnel holder of the system 100′. As illustrated, the plurality of handles 216 can extend outward from the rim 206′ with each handle 216 being substantially rectangular. Each handle 216 can include at least one notch 201 to mate with a corresponding component on a beverage dispenser 300′ to lock the funnel 200′ in place on the beverage dispenser 300′. In the embodiment illustrated by FIG. 2B, the handles 216 are positioned on opposite sides of the rim 206′ from each other, but the handles 216 can extend from any area of the rim 206′ that allows a user to easily grasp the handles 216. Additionally, the funnel 200′ can include any number of handles 216 and the handles 216 can be formed as any shape that allows a user to conveniently remove the funnel 200′.

The funnel 200 can vary in additional ways. For example, funnel outlets with various patterns of the one or more openings are within the scope of this application, including a “Tri-Star” pattern 213, “Tri-Swirl” pattern 215 (described previously), and a “Cross” pattern 217 as shown in FIGS. 3A-3C, as well as other patterns not illustrated. As illustrated, the “Tri-Star” pattern 213 comprises three openings with each opening being shaped like a partial triangle with a curved edge. The “Cross” pattern 217 comprises four openings with each opening being shaped like a partial triangle with a curved edge.

In addition to the various pattern possibilities of the openings of the funnel outlet 212, the funnel outlet 212 can extend through an underside 221 of the base 208 in a variety of ways, as shown in FIGS. 3D-3F. As illustrated, three exemplary projection possibilities include a “Regular” projection 223, a “Flat” projection 225, and a “Extended” projection 227. The “Regular” projection possibility includes a substantially flat portion 229 projecting from the underside 221 of the base 208, and further includes a point 231 attached to the flat portion 229 and extending downward away from the flat portion 229. In the “Flat” projection 224 possibility, the funnel outlet 212 includes the substantially flat portion 229 projecting from the underside 221 of the base 208, without the point 231 of the “Regular” option. Finally, the “Extended” projection 227 possibility includes the flat portion 229 projecting from the underside 221 of the base 208 and a triangular region 233 extending downward away from the flat portion 229.

Each of the funnel outlet projection possibilities and the funnel outlet patterns can be combined in any manner to form a different funnel. Further, the pitch angle of the base 208 can vary between about 0 degrees and even up to about 90 degrees. By way of example, pitch angles between about 5-15 degrees at 2.5-degree increments are discussed. Certain pitch angles can be desirable to alter mixing while minimizing churn and carbonation loss in the fluid, and by varying the pitch angle, the speed of dispense and the stream quality from the funnel can be affected. These pitch angles can be combined with the funnel outlet projection possibilities and the funnel outlet patterns as well. These combinations can result in many different funnel varieties, with the illustrated variations described herein being summarized in the chart depicted in FIG. 3G. As shown, each of the “Tri-Star” 213, “Tri-Swirl” 215, and “Cross” 217 funnel patterns are combinable with each of the “Regular” 223, “Flat” 225, and “Extended 227” projection possibilities at any of the five funnel pitch angle possibilities. In total, these three variables yield forty-five possible funnel types among the described variations. However, while forty-five variations are depicted in the chart, more are possible, as explained herein, the specifically illustrated variations of each of the funnel variables are not intended to be limiting.

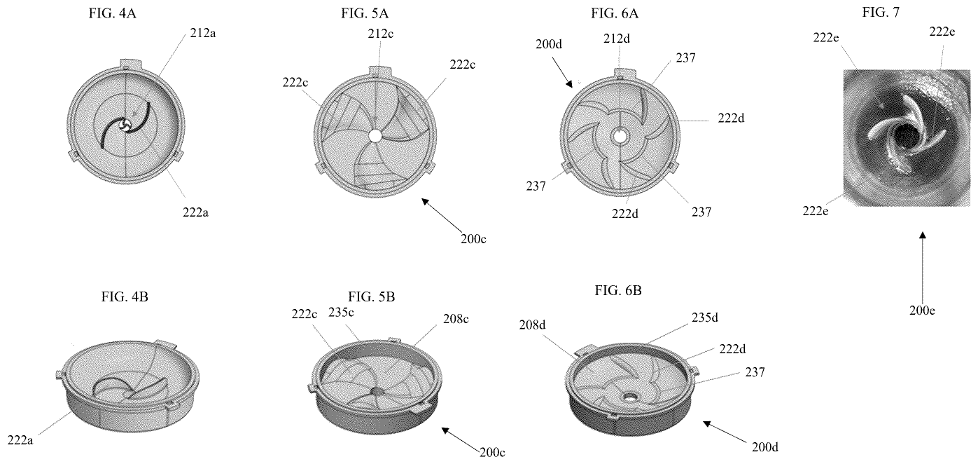

As explained above, the ribs of the funnel can vary in form and/or number. For example, in addition to the variations described above, another rib arrangement, dubbed the “Duo-Swirl” configuration, is illustrated in FIGS. 4A-4B. The “Duo-Swirl” configuration is similar to the “Tri-Swirl” configuration except only two ribs 222a are included in the “Duo-Swirl” configuration, and the two ribs 222a are evenly spaced apart around a funnel outlet 212a. Like the “Tri-Swirl” configuration, the “Duo-Swirl” configuration is compatible with any of the other funnel features described herein.

Turning to FIGS. 5A-5B the “Tri-Swirl 2.0” configuration can include three ribs 222c evenly spaced apart around a funnel outlet 212c. This configuration differs from the designs discussed thus far in that a base 208c is flat and the funnel 200c includes a generally cylindrical inner wall 235c, which may or may not include a curve where the inner wall 235c meets the base 208c, similar to how the sidewall 210 can curve where the sidewall 210 meets the base 208 of the funnel 200. Further, each of the three ribs 222c can be formed as mounds protruding upward from the base 208c, such that fluid rolls off of the mounds and onto the flat base 208c to be guided to the funnel outlet 212c. As fluid is circulated in the funnel 200c, the ribs 222c in this variation serve to churn and mix the fluid with the additive(s) while simultaneously guiding it toward the funnel outlet 212c. While three ribs 222c are depicted in FIGS. 5A-5B, other variations featuring a different number of the mounds are also contemplated herein.

FIGS. 6A-6B illustrate the “Tri-Swirl 3.0” configuration which can include six ribs 222d spaced apart around a funnel outlet 212d. Similar to the “Tri-Swirl 2.0,” a base 208d of the “Tri-Swirl 3.0” configuration can be generally flat and the funnel 200d can include a generally cylindrical inner wall 235d, which may or may not include a curve where the inner wall 235d meets the base 208d, similar to how the sidewall 210 can curve where the sidewall 210 meets the base 208 of the funnel 200. However, the one or more ribs 222d of the “Tri-Swirl 3.0” configuration do not extend all the way to the funnel outlet 212d. Rather, three curved ridges 237 are spaced radially outward from and around the funnel outlet 212d. As shown, one rib 222d extends from each end of each ridge 237 to the inner wall 235d at an angle to direct fluid to the funnel outlet 212d. The purpose of this design illustrates a base 208d having regions of varied height, where higher regions divert fluid to the lower regions, which can assist in dispsensing.

FIG. 7 illustrates that a “Quad-Swirl 1.0” configuration of a funnel 200e is similar to the “Duo-Swirl” and “Tri-Swirl 1.0” configurations except the “Quad-Swirl 1.0” configuration can include four ribs 222e.

However, in alternative embodiments, the funnel 200 can include any number of ribs 222 and the ribs 222 can form any shape and pattern that guides fluid to the fluid outlet 212.

In operation, the funnels described herein serve to combine ingredients of a beverage while minimizing loss of carbonation when the beverage is carbonated. While reference is made to the funnel 200, the description provided is applicable to any of the funnels described herein and should not be limiting. In some embodiments, the fluid that flows from the mixing chamber 202 to the funnel outlet 212 can comprise a combined fluid CF including a primary fluid PF and an additive AD. The primary fluid PF can comprise any fluid suitable for user consumption, such as water or carbonated water, for example, and the additive AD can comprise any substance designed to enhance a characteristic (e.g., taste, texture, caffeine content, etc.) of the primary fluid PF. For example, as discussed above, the additive AD can comprise a flavorant, a vitamin, or a food dye.

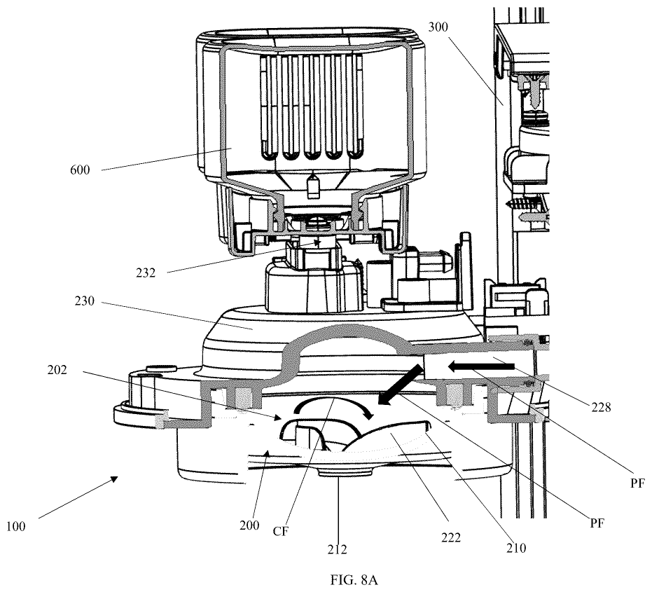

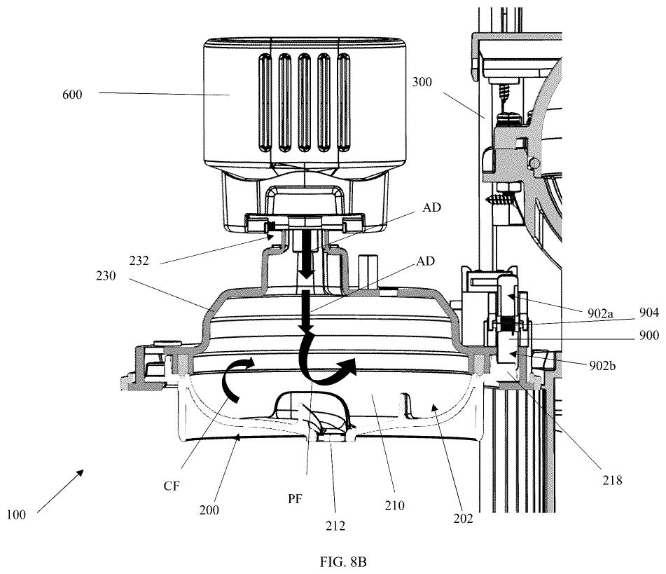

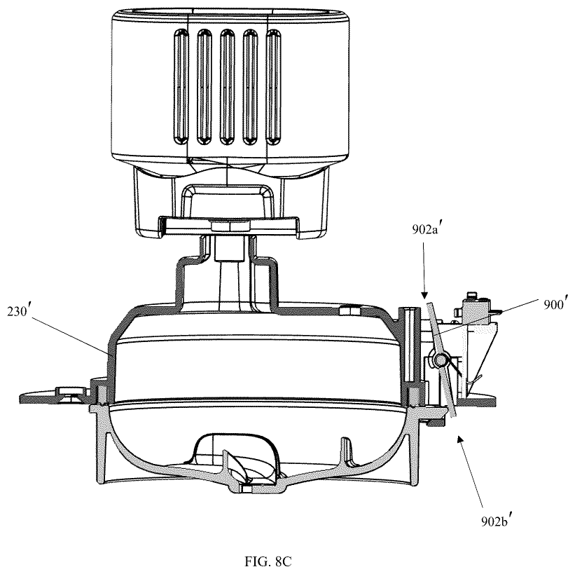

Just as the funnel 200 can receive any fluid to be used in beverage creation, when a user wishes to create a combined fluid CF, the funnel 200 can receive the primary fluid PF and additive AD from the beverage dispenser 300. As discussed above, the base 208 and the sidewall 210 can together define a mixing chamber 202 and therefore a mixing area for combining the primary fluid PF with the additive AD to create the combined fluid CF. For example, creation of the combined fluid CF can begin when the primary fluid PF originating in the fluid reservoir 400 reaches the primary outlet 228. As shown in FIG. 8A, the primary outlet 228 can extend through the cover 230 of the funnel 200 and can be positioned substantially tangential to the sidewall 210. In operation, this positioning of the primary outlet 228 relative to the mixing chamber 202 is designed to cause the primary fluid PF to swirl around the sidewall 210 after the primary fluid PF exits the primary outlet 228 and is received by the funnel 200, thereby creating a vortex. Beneficially, the one or more ribs 222 can help minimize the amount of primary fluid PF that swirls around the funnel 200 at any given time, since the one or more ribs 222 are designed to streamline fluid toward the funnel outlet 212. Minimizing the amount of primary fluid PF in this way can mean that the fluid exits the funnel outlet 212 efficiently and at a consistent pace, thereby decreasing the amount of time the user must wait for their beverage, and reducing any post-dispense drip that might otherwise leak out of the funnel 200.

Turning to FIG. 8B, as the primary fluid PF swirls around the sidewall 210, the system 100 is designed to release the additive AD from the containers 600 so that the additive AD enters the mixing chamber 202 via at least one secondary outlet 232 of the beverage dispenser 300. The at least one secondary outlet 232 can be positioned above the funnel 200 so that the additive AD enters the funnel 200 from above. Next, the additive AD combines with the primary fluid PF in the mixing chamber 202 while the primary fluid PF continues to swirl in the vortex, and the resulting blend of primary fluid PF and additive AD comprises the combined fluid CF. Additionally, combining the primary fluid PF with the additive AD via the vortex can help to minimize carbonation loss in the combined fluid CF, thereby ensuring the quality of the resulting beverage to be enjoyed by the user. It should be understood that the primary outlet 228 and the at least one secondary outlet 232 can be placed anywhere on the beverage dispenser 300 that allows the primary fluid PF and additive AD to be fully combined in the funnel 200.

To initiate creation of beverages, an input (e.g., a microswitch, magnetic sensor, etc.), can be used with beverage systems like system 100. As one example illustrated by FIG. 8B, actuation of an input 900 can occur when the protrusion 218 contacts the input 900. As shown, the input 900 can comprise a generally flat, elongate member with a top end 902a, a bottom end 902b, and a pivot point 904 positioned between the top end 902a and the bottom end 902b. A spring can be positioned partially inside a hole of the pivot point 904 and operate to pivot the top end 902a and the bottom end 902b toward and away from the funnel 200. As shown, the input 900 can be positioned between the funnel 200 and the beverage dispenser 300 to allow the protrusion 218 to contact and therefore actuate the input 900 when the mounting ring 800 (discussed below in more detail) is rotated toward the beverage dispenser 300 and the funnel 200 is positioned within the mounting ring 800. In this specific example, the top end 902a can be pivoted toward the primary outlet 228 and the bottom end 902 can be pivoted away from the primary outlet 228 when the mounting ring 800 is rotated toward the beverage dispenser 300. Actuation of the input 900 is designed to inform the system 100 that the funnel 200 is present and therefore operation can proceed. The system 100 is further designed such that the primary fluid PF will not be released from the fluid reservoir 400 and the additive AD will not be released from the containers 600 if the input 900 is not actuated. This way, the system 100 is unlikely to make a mess by spilling fluid on a countertop or other surface when the funnel 200 is not present to catch the fluid.

A variation of the input 900, input 900′, is depicted in FIG. 8C. The input 900′ is similar to the input 900 in many ways, and for brevity, like features will not be described again. As shown, the top end 902a′ can be pivoted toward the funnel cover 230′ and the bottom end 902b′ can be pivoted away from the funnel cover 230′ when the mounting ring 800′ is rotated toward a beverage dispenser 300′.

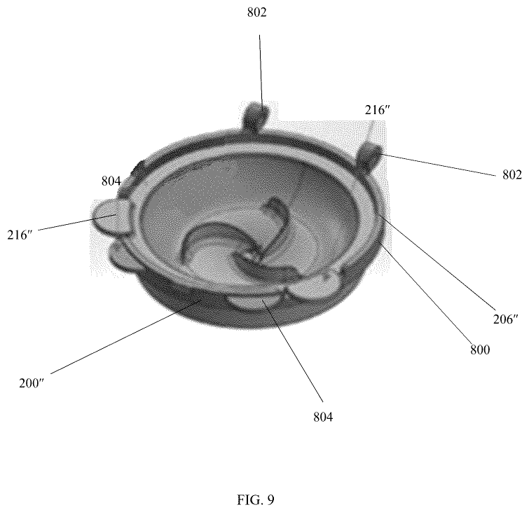

As explained above, the funnels described herein can be mounted to the beverage system in a number of ways, including via a corresponding locking mechanism usable with a beverage dispenser 300″, for example. Beyond these examples, the funnels described herein can be mounted in other ways, including via a mounting ring or similar structure. For example, as illustrated in FIGS. 9-11, a funnel 200″ can be removably coupled to a mounting ring 800 to hold the funnel 200″ in place relative to a corresponding beverage dispenser 300″. The mounting ring 800 can be attached to the beverage dispenser 300″ in a number of ways, including via a one or more coupling members 802, so as to permit rotation of the funnel 200″ down and away from or up and toward the beverage dispenser 300″. In some embodiments, rotation of the funnel 200″ away from the beverage dispenser 300″ and outlets 228″, 232″ can allow a user to remove the funnel 200″ for cleaning, and rotation of the funnel 200″ back toward the beverage dispenser 300″ and outlets 228″, 232″ can secure the funnel 200″ in place for operation of a beverage system 100″ as described herein.

As shown, the funnel 200″ can be positioned within the mounting ring 800 so that the mounting ring 800 extends around a rim 206″ and underneath handles 216″. As explained above, the handles 216″ of the funnel 200″ can be utilized by a user to pull the funnel 200″ out of the mounting ring 800 when the mounting ring 800 is pivoted away from the beverage dispenser 300″. The mounting ring 800 can include coupling members 802 to attach the mounting ring 800 to the beverage dispenser 300″ so as to place the funnel 200″, when positioned within the mounting ring 800, in proper position beneath a primary outlet 228″. The mounting ring 800 can also include one or more brackets 819 to support the funnel 200″. Tabs 804 can be located on the mounting ring 800 to pull the one or more brackets 819 into a cavity 821 underneath the rim 206″ to lock the mounting ring 800 to the funnel 200″. The mounting ring 800 is configured to pivot at the coupling members 802 to thereby rotate the funnel 200″ away from and toward the beverage dispenser 300″ when the funnel 200″ is held within the mounting ring 800. Further, the mounting ring 800 can optionally include an angled stop 806 to limit an extent at which the funnel 200″ can pivot outward away from the beverage dispenser 300″.

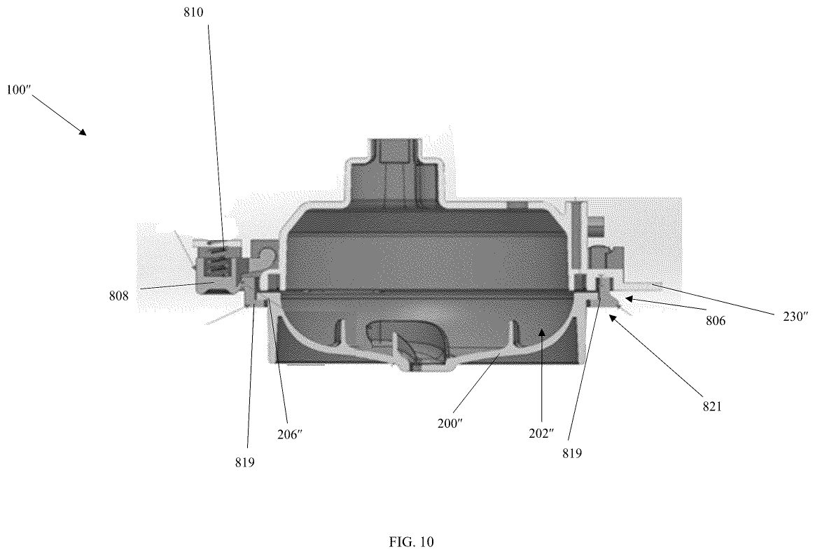

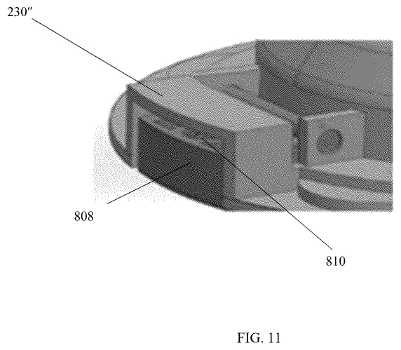

As illustrated in FIGS. 10-11 the system 100″ can include a seal (not shown), a latching member 808, and a release member 810. The seal can surround the rim 206″ of the funnel 200″ and compress the funnel 200″ to prevent fluid from leaking out of the mixing chamber 202″ near the rim 206″. As shown, the latching member 808 can comprise a block positioned within the cover 230″, and the release member 810 can protrude through the cover 230″ and the latching member 808. The release member can comprise a spring or a living hinge, for example. When the funnel 200″ is placed within the mounting ring 800, a latch (not shown) of the one or more brackets 819 can engage with the latching member 808 to pull the funnel 200″ against the seal. When a user wishes to release the funnel 200″ from the mounting ring 800, actuation of the release member 810 can cause the latching member 808 to come out of engagement with the mounting ring 800 to release the funnel 200″ from the mounting ring 800. The mounting ring 800 can be applied to any beverage dispensing system to hold a funnel in place.

Certain exemplary implementations have been described to provide an overall understanding of the principles of the structure, function, manufacture, and use of the systems, devices, and methods disclosed herein. One or more examples of these implementations have been illustrated in the accompanying drawings. Those skilled in the art will understand that the systems, devices, and methods specifically described herein and illustrated in the accompanying drawings are non-limiting exemplary implementations and that the scope of the present invention is defined solely by the claims. The features illustrated or described in connection with one exemplary implementation may be combined with the features of other implementations. Such modifications and variations are intended to be included within the scope of the present invention. Further, in the present disclosure, like-named components of the implementations generally have similar features, and thus within a particular implementation each feature of each like-named component is not necessarily fully elaborated upon.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described implementations. Accordingly, the present application is not to be limited by what has been particularly shown and described, except as indicated by the appended claims. All publications and references cited herein are expressly incorporated by reference in their entirety.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A beverage system, comprising:
a beverage dispenser;
a funnel removably coupled to the beverage dispenser and configured to receive a primary fluid and an additive, the funnel having a mixing chamber configured to combine the primary fluid and the additive into a combined fluid, the mixing chamber having a plurality of ribs configured to direct the combined fluid toward a funnel outlet thereof,
wherein the funnel is configured to receive the primary fluid through a primary outlet of the beverage dispenser positioned substantially tangential to a curve of the funnel such that a fluid vortex is formed in the mixing chamber, and wherein the funnel is configured to receive the additive from at least one secondary outlet of the beverage dispenser.

2. The beverage system of claim 1, wherein each rib of the plurality of ribs extends radially outward from the funnel outlet toward the curve of the funnel.

3. The beverage system of claim 2, wherein each rib of the plurality of ribs is positioned tangentially to the funnel outlet.

4. The beverage system of claim 3, wherein the plurality of ribs includes three ribs evenly spaced apart from each other.

5. The beverage system of claim 4, wherein the funnel outlet includes three openings, and wherein each rib is configured to direct the combined fluid to a respective one of the three openings.

6. The beverage system of claim 1, wherein the at least one secondary outlet is positioned vertically above the funnel.

7. The beverage system of claim 1, wherein the funnel is bowl-shaped.

8. The beverage system of claim 1, wherein the funnel includes a protrusion, and wherein the protrusion is configured to actuate an input disposed on the beverage dispenser.

9. The beverage system of claim 8, wherein the beverage dispenser is operable only when the input is actuated by the protrusion.

10. A beverage system, comprising:
a beverage dispenser;
a mounting ring pivotally connected to the beverage dispenser; and
a funnel removably coupled to the mounting ring and configured to receive a primary fluid and an additive, the funnel having a mixing chamber configured to combine the primary fluid and the additive into a combined fluid,
wherein the mounting ring is configured to support the funnel within the mounting ring, the mounting ring being configured to pivot away from the beverage dispenser in a first position and toward the beverage dispenser in a second position.

11. The beverage system of claim 10, wherein the mounting ring is attached to the beverage dispenser by at least one coupling member, and wherein the mounting ring is configured to pivot from the first position to the second position at the at least one coupling member.

12. The beverage system of claim 11, wherein the funnel includes a protrusion, and wherein the protrusion is configured to actuate an input.

13. The beverage system of claim 12, wherein the beverage dispenser is operable only when the input is actuated by the protrusion.

14. The beverage system of claim 13, wherein the protrusion is configured to actuate the input when the mounting ring is in the second position.

15. The beverage system of claim 10, wherein the funnel is configured to receive the primary fluid through a primary outlet of the beverage dispenser positioned substantially perpendicular to a funnel outlet such that a fluid vortex is formed in the funnel.

16. The beverage system of claim 15, wherein the funnel is configured to receive the additive through at least one secondary outlet of the beverage dispenser positioned vertically above the funnel.

17. The beverage system of claim 10, wherein the mounting ring is configured to pivot away from the primary outlet and the at least one secondary outlet in the first position.

18. The beverage system of claim 10, wherein the primary fluid comprises carbonated water.

19. The beverage system of claim 10, wherein the mixing chamber includes a plurality of ribs configured to direct the combined fluid toward the funnel outlet thereof.
